(19) United States
(12) Patent Application Publication
(10) Pub. No.: US 2008/0001907 A1
(43) Pub. Date: Jan. 3, 2008

(54) Method and apparatus for high efficiency liquid crystal displays using polarization sheet

(76) Inventors: Achintya K. Bhowmik, Milpitas, CA (US); Jim Kardach, Saratoga, CA (US); David Williams, San Jose, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/480,138

(22) Filed: Jun. 30, 2006

(51) Int. Cl. G09G 3/36

(52) U.S. Cl. 345/102

(57) ABSTRACT

An apparatus and system for improving liquid crystal display efficiency by utilizing a polarization sheet. The polarization sheet includes a plurality of prisms capable of separating light source into vertically and horizontally polarized light. A plurality of half wave plates are used to rotate one of the polarized light to create a uniformly polarized light beams. A liquid crystal display (LCD) capable of receiving uniformly polarized light beams. Other embodiments of inventions are described in the claims.

### FIELD

An embodiment of the present invention relates to improving liquid-crystal display efficiency.

### BACKGROUND

There is always a constant need for improving power consumption in portable electronic devices because these devices are powered by fuel cells or batteries with limited power resource. In a mobile device that includes a liquid crystal display (LCD), the LCD is generally the highest power consuming component in comparison to other components in the mobile device. For example, on average, the LCD consumes 30-50% of the total power and a CPU consumes merely 9% of the total power in a mainstream notebook computer. The power consumption of the LCD may depend on the brightness setting. For example, the brighter the LCD is set, the more power the LCD may consume. Therefore, the more power each component consumes, the shorter life a battery or a fuel cell may be.

When the LCD consumes power from the battery, most of the power consumption is attributed to the backlight. A backlight is a form of illumination used in an LCD. Backlights illuminate the LCD from either the side or the back of the LCD. However, on average, only 4-8% of the light emitted from the light source of a backlight module is transmitted. Most of the light emitted is lost to a back polarizer currently used in most of the mobile devices that incorporate LCD displays. When a light source emits light, the light beams can travel in all directions and substantially unpolarized. The back polarizer is used in the LCD device to ensure that the emerging light is polarized in one direction by absorbing light that is polarized in other directions, and therefore filtering light beams through the back polarizer only if the light beams are polarized in the intended direction. The absorbed light is transformed to a different energy state, such as heat. Because a traditional LCD used in a mobile device does not provide an efficient polarization mechanism, more than 50% of light emitted from the light source is lost.

### BRIEF DESCRIPTION OF THE DRAWINGS

Various embodiments of the invention are illustrated by way of example and not by way of limitation in the figures of the accompanying drawings in which like references indicate similar elements. It should be noted that references to “an,” “one,” or “various” embodiments in this disclosure are not necessarily to the same embodiment, and such references mean at least one.

FIG. 1A depicts a two dimensional view of the electromagnetic field of the light and the light ray.

FIG. 1B illustrates a three dimensional electromagnetic field as the light moves in a single continuous direction

FIG. 1C illustrates a light beam with a vertically polarized component 103 and a horizontally polarized component 101 in a three dimensional plane view.

FIG. 1D illustrates a light beam with a vertically polarized component 103 and a horizontally polarized component 101 in a two dimensional plane view.

FIG. 1E illustrates separating light into vertically and horizontally polarized light beams using a prism with a polarization filter.

FIG. 1F illustrates altering the polarization of the light beams using a half wave plate.

FIG. 2 depicts the cross section through a device with a back polarizer.

FIG. 3 depicts the cross section through a device with a polarization sheet according to an embodiment of the invention.

FIG. 4A depicts a cross section or a two dimensional view using a polarization sheet according to one embodiment of the inventions.

FIG. 4B depicts a three dimensional view of the example described in FIG. 4A.

FIG. 5A depicts an example of using a polarization sheet without half wave plates according to one embodiment of the invention.

FIG. 5B depicts a three dimensional view of the example described in FIG. 5A.

FIG. 6 illustrates a LCD including regions of pixels that anticipates non-uniformly polarized light according to one embodiment of the invention.

FIG. 7 illustrates a block diagram of an example computer system that may use an embodiment of polarization sheet.

### DETAILED DESCRIPTION

In the following description, numerous specific details are set forth. However, it is understood that those of ordinary skill in the art will appreciate that the description given herein is for explanatory purposes only and is not intended to limit the scope of the invention.

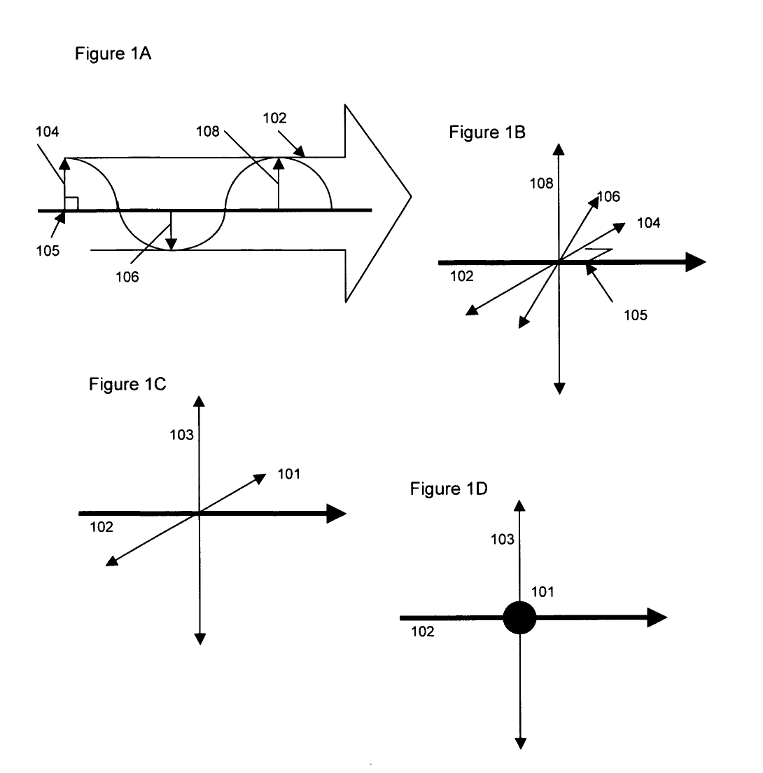

Light can be characterized in both its electromagnetic field and the direction that it travels. Generally, the light travels in one single continuous direction as depicted in FIG. 1A. This single continuous direction in which the light travels may be called the light ray. In FIG. 1A, a light ray 102 is shown to travel towards the right from the view of a reader.

Furthermore, the light can also be characterized in terms of its electromagnetic field. In a two dimensional plane view as shown in FIG. 1A, the electromagnetic field is depicted as the up and down arrows in the amplitude value. Arrows 104, 106, and 108 describe the amplitude measures of the electromagnetic field of the light in a two dimensional plane view.

However, light does not travel in a two dimensional plane view but rather, it travels in a three dimensional space. At any given time as the light travels towards the right, the electromagnetic field 104, 106, and 108 are perpendicular to the light ray 102. In other words, the electromagnetic field of the light is perpendicular to the direction that light travels. Because light travels in the three dimensional space, the electromagnetic field 104, 106, 108 are also moving in a spiral manner along the light ray 102.

FIG. 1B illustrates a three dimensional electromagnetic field as the light moves in a single continuous direction. As shown in FIG. 1B, the electromagnetic field moves in all directions rather than merely the up and down directions in a two dimension plane as depicted in FIG. 1A. An electromagnetic field may be described by a vertically and a horizontally component. These components may be referred to as the vertically polarized and horizontally polarized light beams.

For the purpose of discussing the embodiments of the present invention, vertically polarized and horizontally polarized light beams will be depicted both in a three dimension and a two dimension space plane view. For example, FIG. 1C illustrates a light beam with a vertically polarized component 103 and a horizontally polarized component 101 in a three dimensional plane view. FIG. 1D illustrates a light beam with a vertically polarized component 103 and a horizontally polarized component 101 in a two dimensional plane view. The horizontally polarized component 101 is described as polarized to the norm of the paper. In other words, in a two dimensional space, the horizontally polarized component 101 is pointing through the paper from the perspective of a reader of this discussion.

The amount of light transmitted to a viewer or a viewing device such a LCD may be controlled by inserting a polarize filter. For example, a polarized sunglasses. A horizontally polarized filter filters out the vertical components of a light beam by absorbing the vertical electromagnetic field. Similarity, a vertically polarized filter filters out the horizontal component of the light beam by absorbing the horizontal electromagnetic field. Result in these types of polarization is a reduction of light transmitted.

FIG. 1E illustrates separating light into vertically and horizontally polarized light beams using a prism with a polarization filter. As shown in FIG. 1E, light source 108 enters a prism 110 and the light beams that are emitted from the light source 108 are separated into light beams in directions 112 and 114. The light beam in direction 112 may represent a vertically polarized light and illustrated by the angled polarization direction 113. The light beam 114 may represent a horizontally polarized light and the direction of the polarization may be illustrated by the left and right polarization direction 111.

The polarization described in FIG. 1E depends on the direction of a polarization filter 115. As discussed above, a horizontal polarization filter absorbs the vertical light component and a vertical polarization filter absorbs out the horizontal light component. In this example, the polarization is a vertical polarization filter because the polarization filter 115 permits vertically polarized light 112, shown as the vertical polarization direction 113, to pass through the polarization filter 115. A person in the skilled of the art may appreciate that a horizontal polarization filter may be used instead and permits horizontally polarized light beam to be pass through the polarization filter 115.

A typical LCD includes multiple liquid crystal cells or pixels. The amount of light to be displayed on the LCD may be controlled by these liquid crystal cells or pixels. By default, each liquid crystal cells or pixels may be configured to permit the light to pass through and only to block the light when an electronic signal is received. For example, in a default “on” state, the light may be passed through, and in an “off” state, no light may be passed through. Various states in between the “off” and the “on” states may also be configured to control the degree of light passing through. This may be used to control the contrast and the brightness of the display. The liquid crystal cells or pixels in a LCD are designed in a homogenous way and therefore respond to electronic signals in a homogenous way.

Even though the amount of light to be displayed may be manipulated through the manipulation of the liquid crystal cells or pixels, it does not solve the light loss problem that occurs in the back polarizer used in the mobile devices. A back polarizer is an essential component in the traditional electro-optical spatial light modulation mechanism employed in most of the LCD since the liquid crystal cells or pixels require polarized light to modulate the transmission of light.

In addition to absorbing light beams by using the polarized filters, a light beam may be altered in several ways. One way to alter a light beam is through the use of a prism and another way is through the use of a half wave plate.

FIG. 1F illustrates altering the polarization of the light beams using a half wave plate. A light emitted from light source 108 is vertically polarized as illustrated by the polarization direction 150. A half plate 140 may be used to rotate the polarization of the light beam in a 90 degree angles. As shown in FIG. 1F, the vertically polarized light beams after passing through the half plate 140 becomes a horizontally polarized light beam, as illustrated by the polarization direction 155. Similarly, a person in the skilled of the art may appreciate that when a horizontally polarized light beam passes through the half plate 140, the output would be a vertically polarized light beam.

A limitation for using a prism and a mirror as illustrated in FIG. 1C with the LCD designs is that because the polarizing function precedes the brightness homogenization scheme via diffusion and scattering, the degree of linear polarization of light entering liquid crystal devices is degraded and resulting in loss of contrast.

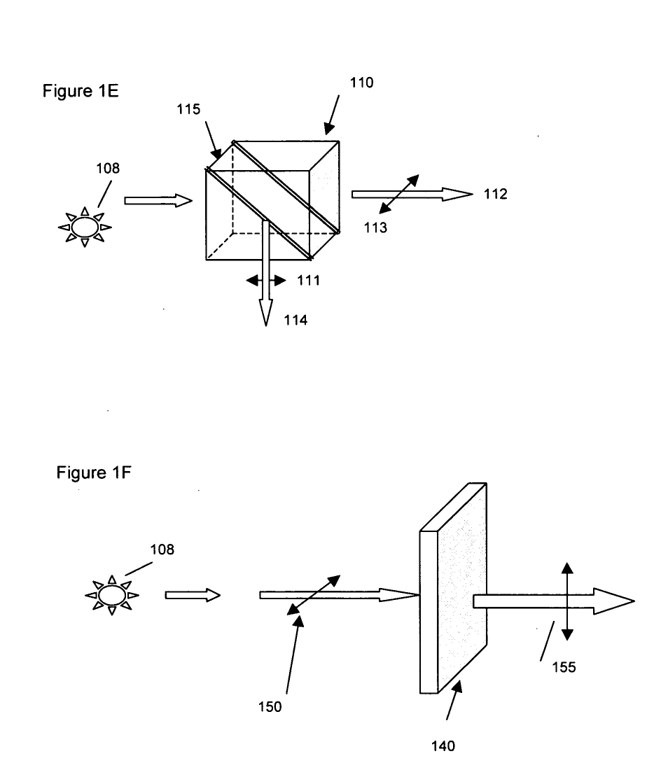

FIG. 2 depicts the cross section through a device with a back polarizer. A light source 220 emits light beams towards a backlight diffuser or a backlight guide 214. The light beams are diffused through the backlight diffuser 214 and travel towards a back polarizer 212. The light beams continue to travel through an Indium Tin Oxide (ITO) electrode 210. The light beams enter the liquid crystal cell 208 and then through another ITO electrode 206. The light beams then enter a color filter 204. Eventually, the light beams arrive at the front polarizer 202. As discussed above, existing back polarizer absorbs most of the light passing through and therefore causing light loss.

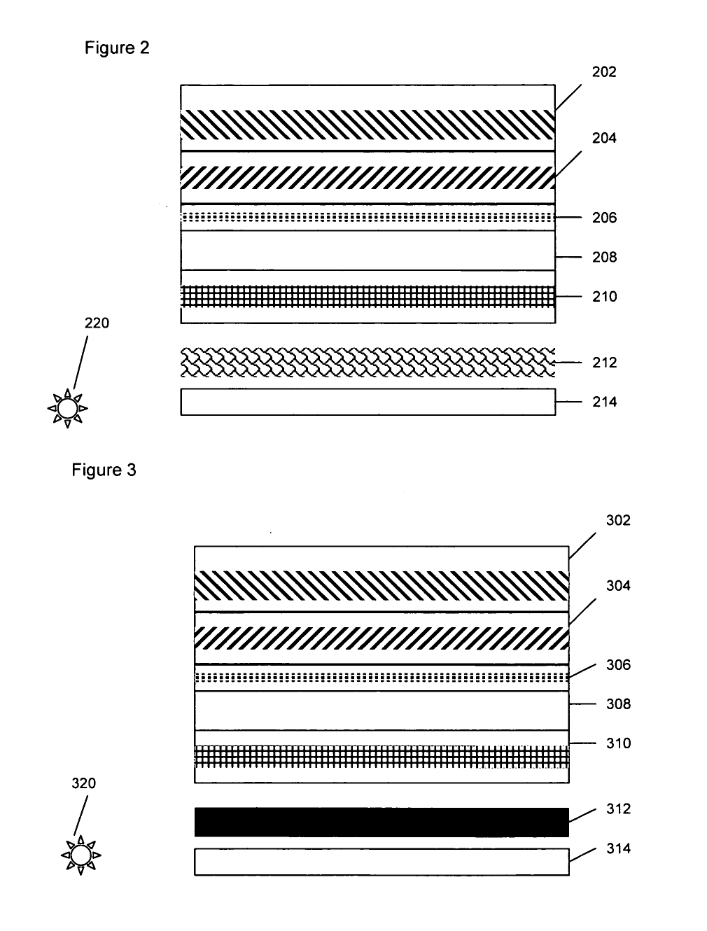

FIG. 3 depicts the cross section through a device with a polarization sheet according to an embodiment of the invention. Light source 320 emits light beams towards a backlight diffuser 314. The light beams are diffused through the backlight diffuser 314 and travel towards a polarization sheet 312. The light beams continue to travel through an Indium Tin Oxide (ITO) electrode 310. The light beams enter the liquid crystal cell 308 and then through another ITO electrode 306. The light beams then enter a color filter 304. Eventually, the light beams arrive at the front polarizer 302.

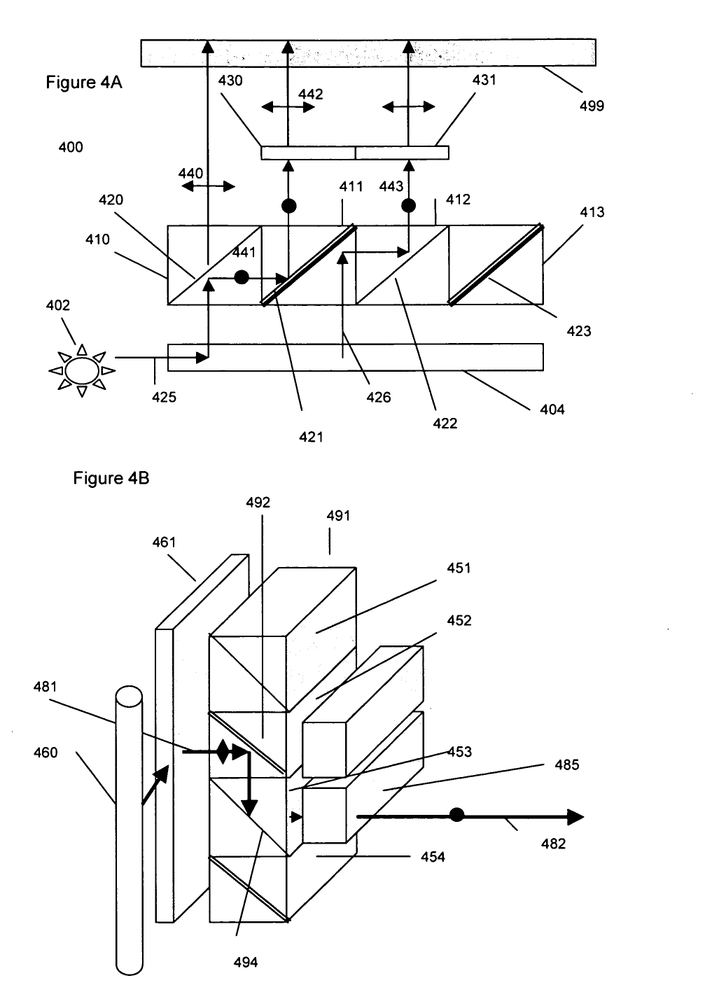

FIG. 4A depicts a cross section or a two dimensional view using a polarization sheet according to one embodiment of the inventions. As shown in FIG. 4A, a plurality of prisms may be concatenated to form a polarization sheet 400. The array of prisms 410, 411, 412, and 413 may be assembled linearly to receive light from a backlight source 402. The backlight source 402 is diffused through a backlight diffuser or a backlight guide 404. The backlight diffuser or the backlight guide 404 passes the light emitted from the backlight source 402 to the polarization sheet 400.

One skilled in the art may appreciate that a prism may be made of any material that is capable of separating light into light beams in different directions. For example, it may also be appreciated that a prism may be a glass or a plastic prism. Furthermore, a prism may also be in any shape so long the plurality of prisms may be concatenated in an array to form a polarization sheet. In the example depicted in FIG. 4A, four cube prisms are shown. The cube prism may also be called a box prism or a box polarizer. It may be appreciated that any number of prisms may be used depending on other criteria. For example, the number of prism used may be determined based on the size of a LCD display.

In one embodiment of the invention, polarization filter 420 and 422, and mirrors 421 and 423 may be used with the prisms 410, 412, 411 and 413 respectively, as shown in FIG. 4A, to alter the polarization of the light beams. In another embodiment of the invention, half wave plates 430 and 431 may be placed adjacent to prisms 411 and 412, respectively, to rotate the polarized light beams.

The directions in which the polarization filters and the half wave plates rotate the light beams depend on the type of the polarization filters. As discussed above, if a horizontal polarization filter is used, vertically polarized light beams may be absorbed and allowing only the horizontally polarized light beams to pass through the horizontal polarization filter. In contrast, if a vertical polarization filter is used, horizontal polarized light beams may be absorbed and allowing only the vertically polarized light beams to pass through the vertical polarization filter.

For the purpose of illustrating an embodiment of the invention, the polarization filters 420 and 422 in FIG. 4A are horizontal polarization filters. One skilled in the art would appreciate that vertical polarization filters may be used instead of the horizontal polarization filters. In FIG. 4A, a light beam 425 is unpolarized. As discussed above, an unpolarized light beams encompasses light beams that polarized in all directions. When the unpolarized light beam 425 passes through the prism 410, the unpolarized light beam 425 is separated into vertically and horizontally polarized light beams (not shown in FIG. 4A). After the vertically and the horizontally polarized light beams reach the horizontal polarization filter 420, only the horizontally polarized light beams are passed through. These horizontally polarized light beams are shown as the polarization direction 440, after passing through the horizontal polarization filter 420.

The vertically polarized light beams that are not passed through the horizontal polarization filter 420 are shown by the black dot 441 (hereafter referred to as the vertically polarized light beams 441). The vertically polarized light beams 441 may be deflected through the polarization filter 420 and reflected through the mirror 421. Because a mirror does not alter the polarization of a light beam or filter the light beams, the mirror 421 merely reflects the vertically polarized light beams and does not change the polarization of the vertically polarized light beams 441. Therefore, the vertically polarized light beams 441 remains vertically polarized.

After the vertically polarized light beams 441 pass through the half wave plate 430, the polarization of the vertically polarized light beams 441 are altered 90 degrees and result in the horizontal light beams. This change of polarization is illustrated by the left and right arrow 442.

In one embodiment of the invention, an unpolarized light beam 426 is diffused through the backlight diffuser and the backlight guide 404. The unpolarized light beam 426 is separated into vertically and horizontally polarized light beam when it enters the prism 411. However, because a mirror merely reflects the light beam and does not filter or alter the polarization, the unpolarized light beam 426 continues to travel towards the horizontal polarization filter 422. In this embodiment of the invention, the unpolarized light beam 426 is deflected by the horizontal polarization filter 422. Because only the horizontally polarized components of the light beam 426 may be passed through the horizontal polarization filter 422, the vertically polarized component of the light beam 426 continues to travel towards the half wave plate 431. The vertical direction of the polarization of the light beam 426 is illustrated by the black dot 443. After the vertically polarized light beam 426 passes through the half plate 431, the polarization of the vertically polarized light beam 426 is altered 90 degrees and result in the horizontally polarized light beams.

The polarization alteration by the half wave plate 430 and 431 resulting in a uniformly polarized light beams. As shown in FIG. 4A that all the light beams in area 499 are horizontally polarized. One person skilled in the art may appreciate that when the polarization filters 420 and 422 are vertical polarization filters, the half wave plates 430 and 431 may be used to alter horizontal polarized light beams to provide all uniform polarized light beams in a vertical direction.

FIG. 4B depicts a three dimensional view of the example described in FIG. 4A. As shown in FIG. 4B, a plurality of prisms, namely, prisms 451, 452, 453 and 454 are formed in an array into a polarization sheet 491. A backlight source 460 is used to emit or provide light into a backlight diffuser or a backlight guide 461. In one embodiment of the invention, the backlight source 460 emits light from the side of the backlight diffuser or the backlight guide 461.

The backlight source460 may be a cold cathode tube or a light emitting diode (LED) bar. Adjacent to the backlight diffuser 461, as shown in FIG. 4B, is a polarization sheet 491. In one embodiment of the invention, the polarization sheet 491 may include an array of rectangular prisms with square cross sections as depicted by the rectangular prisms 451, 452, 453, and 454.

In one embodiment of the invention, the backlight diffuser of the backlight guide 461 may be selected so that no particular polarization (i.e. vertically or horizontally polarization) is favored. An unbiased backlight diffuser or backlight guide may be used to ensure that the light is scattered evenly towards the polarization sheet 491 and that no particular areas of the polarization sheet 491 receives additional light than other areas of the polarization sheet 491.

In this example, a horizontally polarized light 481 travels through the prism 452 and may be reflected via a mirror 492 and deflected via a horizontal polarization filter 494. Because the horizontal component of the horizontally polarized light 481 is passed through the horizontal polarization filter 494, the portion of the horizontally polarized light 481 that is not passing through the horizontal polarization filter 494 is deflected or transmitted towards a half wave plate 485 as a vertically polarized light 482.

In one embodiment of the invention, the vertically polarized light 482 is rotated 90 degrees through the half wave plate 485 to become a horizontally polarized light. As discussed with respect to FIG. 4A, this rotation ensures that light polarized in different polarization when entering the prisms is now polarized in one direction or uniformly polarized. In one embodiment of the invention, half wave plate may be a birefringent film.

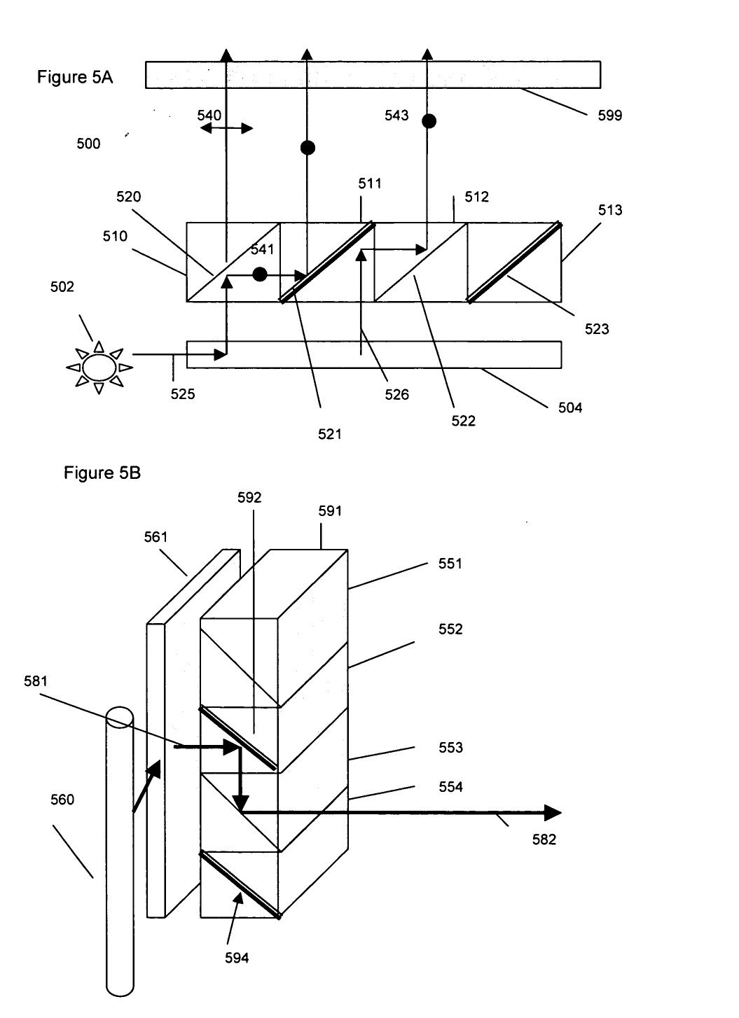

FIG. 5A depicts a cross section or a two dimensional view using a polarization sheet according to one embodiment of the inventions. As shown in FIG. 5A, a plurality of prisms may be concatenated to form a polarization sheet 500. The array of prisms 510, 511, 512, and 513 may be assembled linearly to receive light from a backlight source 502. The backlight source 502 is diffused through a backlight diffuser or a backlight guide 504. The backlight diffuser or the backlight guide 504 passes the light emitted from the backlight source 502 to the polarization sheet 500.

One skilled in the art may appreciate that a prism may be made of any material that is capable of separating light into light beams in different directions. For example, it may also be appreciated that a prism may be a glass or a plastic prism. Furthermore, a prism may also be in any shape so long the plurality of prisms may be concatenated in an array to form a polarization sheet. In the example depicted in FIG. 5A, four cube prisms are shown. The cube prism may also be called a box prism or a box polarizer. It may be appreciated that any number of prisms may be used depending on other criteria. For example, the number of prism used may be determined based on the size of a LCD display.

In one embodiment of the invention, polarization filter 520 and 522, and mirrors 521 and 523 may be used with the prisms 510, 512, 511 and 513 respectively, as shown in FIG. 5A, to alter the polarization of the light beams.

As discussed above, if a horizontal polarization filter is used, vertically polarized light beams may be absorbed and allowing only the horizontally polarized light beams to pass through the horizontal polarization filter. In contrast, if a vertical polarization filter is used, horizontal polarized light beams may be absorbed and allowing only the vertically polarized light beams to pass through the vertical polarization filter.

For the purpose of illustrating an embodiment of the invention, the polarization filters 520 and 522 in FIG. 5A are horizontal polarization filters. One skilled in the art would appreciate that vertical polarization filters may be used instead of the horizontal polarization filters. In FIG. 5A, a light beam 525 is unpolarized. As discussed above, an unpolarized light beams encompasses light beams that polarized in all directions. When the unpolarized light beam 525 passes through the prism 510, the unpolarized light beam 525 is separated into vertically and horizontally polarized light beams (not shown in FIG. 5A). After the vertically and the horizontally polarized light beams reach the horizontal polarization filter 520, only the horizontally polarized light beams are passed through. These horizontally polarized light beams are shown as the polarization direction 540, after passing through the horizontal polarization filter 520.

The vertically polarized light beams that are not passed through the horizontal polarization filter 520 are shown by the black dot 541 (hereafter referred to as the vertically polarized light beams 541). The vertically polarized light beams 541 may be deflected through the polarization filter 520 and reflected through the mirror 521. Because a mirror does not alter the polarization of a light beam or filter the light beams, the mirror 521 merely reflects the vertically polarized light beams and does not change the polarization of the vertically polarized light beams 541. Therefore, the vertically polarized light beams 541 remains vertically polarized.

In one embodiment of the invention, an unpolarized light beam 526 is diffused through the backlight diffuser and the backlight guide 504. The unpolarized light beam 526 is separated into vertically and horizontally polarized light beam when it enters the prism 511. However, because a mirror merely reflects the light beam and does not filter or alter the polarization, the unpolarized light beam 526 continues to travel towards the horizontal polarization filter 522. In this embodiment of the invention, the unpolarized light beam 526 is deflected by the horizontal polarization filter 522. Because only the horizontally polarized components of the light beam 526 may be passed through the horizontal polarization filter 522, the vertically polarized component of the light beam 526 continues to travel towards the half wave plate 531. The vertical direction of the polarization of the light beam 526 is illustrated by the black dot 543.

As shown in FIG. 5A, the polarization of the light beams 525 and 526 are different and therefore, the light beams in area 599 are non-uniformly polarized.

FIG. 5B depicts a three dimensional view of the example described in FIG. 5A. As shown in FIG. 5B, a plurality of prisms, namely, prisms 551, 552, 553 and 554 are formed in an array into a polarization sheet 591. A backlight source 560 is used to emit or provide light into a backlight diffuser or a backlight guide 561. In one embodiment of the invention, the backlight source 560 emits light from the side of the backlight diffuser or the backlight guide 561.

The backlight source 560 may be a cold cathode tube or a light emitting diode (LED) bar. Adjacent to the backlight diffuser 561, as shown in FIG. 5B, is a polarization sheet 591. In one embodiment of the invention, the polarization sheet 591 may include an array of rectangular prisms with square cross sections as depicted by the rectangular prisms 551, 552, 553, and 554.

In one embodiment of the invention, the backlight diffuser of the backlight guide 561 may be selected so that no particular polarization (i.e. vertically or horizontally polarization) is favored. An unbiased backlight diffuser or backlight guide may be used to ensure that the light is scattered evenly towards the polarization sheet 591 and that no particular areas of the polarization sheet 591 receives additional light than other areas of the polarization sheet 591.

In this example, a horizontally polarized light 481 travels through the prism 552 and may be reflected via a mirror 592 and deflected via a horizontal polarization filter 594. Because the horizontal component of the horizontally polarized light 581 is passed through the horizontal polarization filter 594, the portion of the horizontally polarized light 481 that is not passing through the horizontal polarization filter 594 is deflected or transmitted towards out of the prism 553 a vertically polarized light 582.

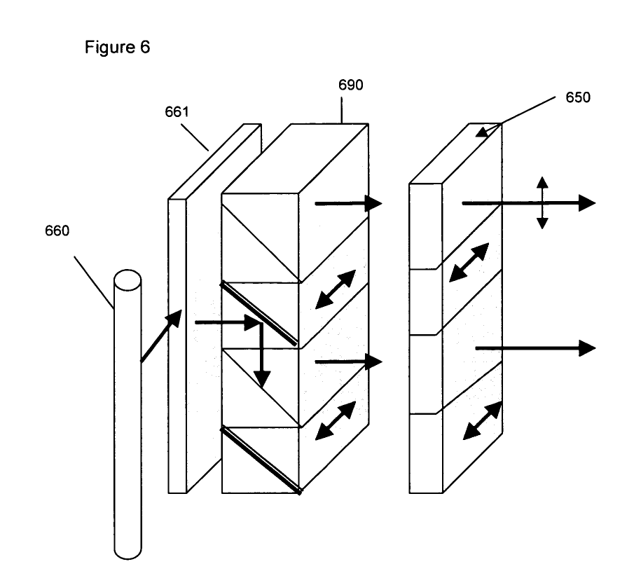

In one embodiment of the invention, a LCD including regions of pixels that anticipate non-uniformly polarized light may be used as depicted in FIG. 6. A LCD 650 may include pixels that when situated over a polarization sheet 690 having regions of the horizontally polarized light, 100% of the horizontally polarized light is transmitted, and when situated over the polarization sheet 690 regions of vertically polarized light, 100% of the vertically polarized light is transmitted. Similar to FIG. 4A and 5B, light is emitted from a light source 660 and diffused via a backlight diffuser 661.

In one embodiment of the invention, a polarization sheet may be used in mobile computing devices to ensure a minimum power loss. Examples of mobile computing devices may be a laptop computer, a cell phone, a personal digital assistant, or other similar device with on board processing power and wireless communications ability that is powered by a Direct Current (DC) power source that supplies DC voltage to the mobile device and that is solely within the mobile computing device and needs to be recharged on a periodic basis, such as a fuel cell or a battery.

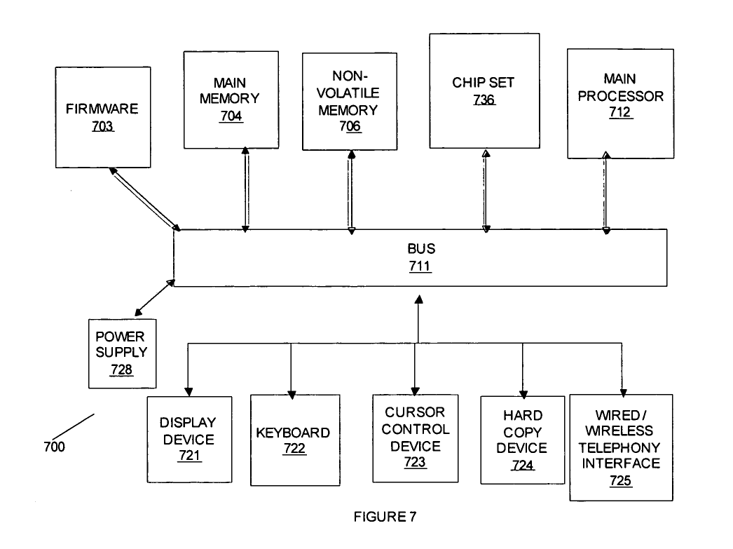

FIG. 7 illustrates a block diagram of an example computer system that may use an embodiment of polarization sheet. In one embodiment, computer system 700 comprises a communication mechanism or bus 711 for communicating information, and an integrated circuit component such as a main processing unit 712 coupled with bus 711 for processing information. One or more of the components or devices in the computer system 700 such as the main processing unit 712 or a chip set 736 may use an embodiment of the polarization sheet. The main processing unit 712 may consist of one or more processor cores working together as a unit.

Computer system 700 further comprises a random access memory (RAM) or other dynamic storage device 704 (referred to as main memory) coupled to bus 711 for storing information and instructions to be executed by main processing unit 712. Main memory 704 also may be used for storing temporary variables or other intermediate information during execution of instructions by main processing unit 712.

Firmware 703 may be a combination of software and hardware, such as Electronically Programmable Read-Only Memory (EPROM) that has the operations for the routine recorded on the EPROM. The firmware 703 may embed foundation code, basic input/output system code (BIOS), or other similar code. The firmware 703 may make it possible for the computer system 700 to boot itself.

Computer system 700 also comprises a read-only memory (ROM) and/or other static storage device 706 coupled to bus 711 for storing static information and instructions for main processing unit 712. The static storage device 706 may store OS level and application level software.

Computer system 700 may further be coupled to or have an integral display device 721, such as a cathode ray tube (CRT) or liquid crystal display (LCD), coupled to bus 711 for displaying information to a computer user. A chipset may interface with the display device 721.

An alphanumeric input device (keyboard) 722, including alphanumeric and other keys, may also be coupled to bus 711 for communicating information and command selections to main processing unit 712. An additional user input device is cursor control device 723, such as a mouse, trackball, trackpad, stylus, or cursor direction keys, coupled to bus 711 for communicating direction information and command selections to main processing unit 712, and for controlling cursor movement on a display device 721. A chipset may interface with the input output devices. Similarly, devices capable of making a hardcopy 724 of a file, such as a printer, scanner, copy machine, etc. may also interact with the input output chipset and bus 711.

Another device that may be coupled to bus 711 is a power supply such as a battery and Alternating Current adapter circuit. Furthermore, a sound recording and playback device, such as a speaker and/or microphone (not shown) may optionally be coupled to bus 711 for audio interfacing with computer system 700. Another device that may be coupled to bus 711 is a wireless communication module 725. The wireless communication module 725 may employ a Wireless Application Protocol to establish a wireless communication channel. The wireless communication module 725 may implement a wireless networking standard such as Institute of Electrical and Electronics Engineers (IEEE) 802.11 standard, IEEE std. 802.11-1999, published by IEEE in 1999.

In one embodiment, the software used to facilitate the above routines or fabricate the above components can be embedded onto a machine-readable medium. A machine-readable medium includes any mechanism that provides (i.e., stores and/or transmits) information in a form accessible by a machine (e.g., a computer, network device, personal digital assistant, manufacturing tool, any device with a set of one or more processors, etc.). For example, a machine-readable medium includes recordable/non-recordable media (e.g., read only memory (ROM including firmware; random access memory (RNA); magnetic disk storage media; optical storage media; flash memory devices; etc.), as well as electrical, optical, acoustical or other form of propagated signals (e.g., carrier waves, infrared signals, digital signals, etc.); etc.

What is claimed is:

1. A method comprising:
emitting light to a light diffuser;
separating the light received from the light diffuser into vertically and horizontally polarized light beams using a polarization sheet, the polarization sheet includes an array of prisms; and
transmitting the vertically and horizontally polarized light beams to a liquid crystal display (LCD), the LCD is controlled by an input/output (I/O) controller.

2. The method of claim 1, further comprising:
rotating all of the vertically polarized light beams or all of the horizontally polarized light beams but not both using a half wave plate so the light beams separated by the polarization sheet are uniformly polarized; and
transmitting the vertically and horizontally polarized light beams to different regions of the LCD.

3. The method of claim 1, further comprising:
if the light beams are vertically polarized, then the LCD transmits vertically polarized light beams in response to a signal to the LCD allowing the LCD to control a level of opaqueness of the LCD screen.

4. The method of claim 1, further comprising:
if the light is horizontally polarized, then the LCD transmits horizontally polarized light beams in response to a signal to the LCD allowing the LCD to control a level of opaqueness of the LCD screen.

5. The method of claim 1, further comprising:
powering the I/O controller by a direct current (PC) power supply.

6. An apparatus comprising:
a light diffuser to receive light;
a polarization sheet situated adjacent to the light diffuser, the polarization sheet includes a plurality of prisms to separate the light into non-uniformly polarized light beams; and
a liquid crystal device (LCD) to receive the non-uniformly polarized light beams.

7. The apparatus of claim 6, further comprising:
a backlight to provide the light from a rear of the LCD.

8. The apparatus of claim 6, wherein each prism of the plurality of prisms separates the light into vertically and horizontally light beams.

9. The apparatus of claim 6, further comprising:
a mobile computing device containing an input/output (I/O) controller to control the LCD, wherein the mobile computing device has a direct current (DC) power supply to power the I/O controller.

10. The apparatus of claim 6, further comprising:
the backlight is a cold cathode tube.

11. An apparatus, comprising:
a light diffuser to receive light; and
a polarization sheet situated adjacent to the light diffuser, the polarization sheet includes a plurality of prisms to separate the light into vertically and horizontally polarized light beams to be transmitted to a liquid crystal display (LCD) of a mobile computing device.

12. The apparatus of claim 11, further comprising:
a half wave plate to rotate all of the vertically polarized light beams or all of the horizontally polarized light beams but not both using a half wave plate so the light beams separated by the polarization sheet are uniformly polarized.

13. The apparatus of claim 11, further comprising:
a plurality of mirrors included in the plurality of prisms to reflect one of the vertically or horizontally polarized light beams.

14. The apparatus of claim 11, further comprising:
a device containing an input/output (I/O) controller to control the LCD, wherein the device has a DC power supply to power the I/O controller.

15. The apparatus of claim 11, further comprising:
a backlight to provide light source to the light diffuser.

16. A system, comprising:
a liquid crystal display (LCD) to display images through light illumination;
a backlight to provide light;
a light diffuser to receive the light from the backlight;
a polarization sheet to receive the light from the light diffuser, wherein the polarization sheet includes a plurality of prisms to separate the light into vertically and horizontally polarized light beams;
an indium tin oxide (ITO) electrode to receive the light beams from the polarization sheet; and
a liquid crystal cell to receive the light beams from the ITO electrode.

17. The system of 16, wherein the LCD is to receive non-uniformly polarized light beams if the light is non-uniformly polarized.

18. The system of 16, wherein the LCD is to receive uniformly polarized light beams if the light source is uniformly polarized.

19. The system of 16, further comprising:
a half wave plate to rotate one of the vertically and horizontally polarized light beams so that all the polarized light beams are directed towards one direction; and
a plurality of mirrors included in the plurality of prisms to reflect all of the vertically polarized light beams or all of the horizontally polarized light beams but not both.

20. The system of 16, further comprising:
a mobile computing device containing an input/output (I/O) controller to control the LCD, wherein the mobile computing device has a DC power supply to power the I/O controller.
